(19) United States
(12) Patent Application Publication
(10) Pub. No.: US 2016/0362937 A1
(43) Pub. Date: Dec. 15, 2016

(54) FORMATION ANALYSIS AND DRILL STEERING USING LATERAL WELLBORES

(71) Applicant: SCHLUMBERGER TECHNOLOGY CORPORATION, Sugar Land, TX (US)

(72) Inventors: Stephen Dyer, Rosharon, TX (US); Reza Taherian, Missouri City, TX (US)

(21) Appl. No.: 14/739,694

(22) Filed: Jun. 15, 2015

(51) Int. Cl. E21B 7/04; G05B 15/02

(52) U.S. Cl. CPC E21B 7/04; G05B 15/02

(57) ABSTRACT

In one possible implementation, a steering control module includes a received signal analysis module configured to analyze transducer signals propagated through a formation between a lateral wellbore and an active well undergoing a drilling operation. The steering control module is also configured to utilize the analyzed transducer signals to direct a steering system to steer a drill in the active well in a desired direction. In another possible implementation, a first set of signals detected in an active well undergoing a drilling operation can be received. The first set of signals can be transmitted by at least one transducer array associated with a lateral wellbore, with the lateral wellbore and the active well being separated by a formation. The detected first set of signals can be analyzed to determine an area of interest in the formation.

### BACKGROUND

In seismic exploration, especially in mature oil and gas fields, a constant challenge exists in developing accurate and efficient techniques for locating remaining or “unswept” resources. The use of multi-lateral and horizontal wells, and the increased use of open hole completions, has in some cases enabled operators to better understand localized variations in reservoirs and better locate potential “pay zones” containing remaining hydrocarbon deposits. In addition, reservoir simulation models, advanced reservoir evaluation/description and production well data (including residual saturation logs), 4-dimensional seismic surveys and tracer tests may also be used to contribute to an operator's understanding of the reservoir.

The above known techniques can be used to plan a drilling trajectory predicted to penetrate an area of interest (i.e. an area believed to include hydrocarbons still existing in the reservoir). Such known techniques can be expensive and carry a high risk that the area of interest will not pay off. Additionally, there is a substantial risk that infill wells created between two existing bore holes may encounter unexpected variations in the formation that were not predicted by any geologic or reservoir description models developed prior to drilling, even in mature fields. As a result, known techniques may not be enough to indicate troublesome localized variations in the formation, which an operator may wish to avoid in order to save time and wear and tear on equipment while drilling to the area of interest.

### SUMMARY

In one possible implementation, a steering control module includes a received signal analysis module configured to analyze transducer signals propagated through a formation between a lateral wellbore and an active well undergoing a drilling operation. The steering control module is also configured to utilize the analyzed transducer signals to direct a steering system to steer a drill in the active well in a desired direction.

In another possible implementation, a first set of signals detected in an active well undergoing a drilling operation can be received. The first set of signals can be transmitted by at least one transducer array associated with a lateral wellbore, with the lateral wellbore and the active well being separated by a formation. The detected first set of signals can be analyzed to determine an area of interest in the formation.

In yet another possible implementation, information can be received regarding waveforms propagated by one or more electric dipoles through a formation between a lateral wellbore and an active well being drilled. The information can be utilized to determine an orientation of a drill in the active well relative to the lateral wellbore.

This summary is not intended to identify key or essential features of the claimed subject matter, nor is it intended to be used to limit the scope of the claimed subject matter in any manner.

### BRIEF DESCRIPTION OF THE DRAWINGS

Features and advantages of the described implementations can be more readily understood by reference to the following description taken in conjunction with the accompanying drawings.

FIG. 1 illustrates an example well site environment in which embodiments of formation analysis and drill steering using lateral wellbores can be employed;

FIGS. 2 and 3 illustrate an example formation analysis and drill steering system that can be used in accordance with various implementations of formation analysis and drill steering using lateral wellbores;

FIG. 4 illustrates an example formation analysis and drill steering system using lateral wellbores in an existing tubing or casing that can be used in accordance with various implementations of formation analysis and drill steering using lateral wellbores;

FIGS. 5 and 6 illustrate an example formation analysis and drill steering system using lateral bores for geo-steering a drill bit towards an area of interest that can be used in accordance with various implementations of formation analysis and drill steering using lateral wellbores;

FIGS. 7 and 8 illustrates an example formation analysis and drill steering system using a lateral wellbore created within the same well as a primary/active well being drilled that can be used in accordance with various implementations of formation analysis and drill steering using lateral wellbores;

FIGS. 9 and 10 illustrate yet another example of a formation analysis and drill steering system utilizing a lateral wellbore with one or more transducer arrays mounted on various points near to, or on, a wellbore's casing in accordance with various implementations of formation analysis and drill steering using lateral wellbores;

FIG. 11 illustrates an example transducer in accordance with example embodiments of formation analysis and drill steering using lateral wellbores;

FIG. 12 illustrates the operation of a transducer in accordance with various embodiments of formation analysis and drill steering using lateral wellbores;

FIG. 13 illustrates an example plot of the variation of signal strength with angle to an electric dipole that can be used in accordance with various implementations of formation analysis and drill steering using lateral wellbores;

FIG. 14 illustrates an example ray diagram that can be used in accordance with various implementations of formation analysis and drill steering using lateral wellbores;

FIGS. 15-16 illustrate example method(s) that can be used in accordance with various implementations of formation analysis and drill steering using lateral wellbores; and

FIG. 17 illustrates an example computing device that can be used in accordance with various implementations of formation analysis and drill bit steering using lateral wellbores.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

As described herein, various techniques and technologies can facilitate the analysis of potential areas of interest in a formation as well as the steering of a drill in a well being drilled towards or away from such areas of interest.

In one possible implementation transducers in a lateral well can be used to discover such areas of interest. It will be understood that the term “lateral” as used herein may include any type of wellbore displaced from a well being drilled, including “sidetrack” wellbores previously drilled as branches off of the well being drilled.

In addition, various techniques and technologies described herein can also be used to determine an existing orientation of the drill to an existing lateral wellbore and steer the drill to a desired orientation relative to the lateral wellbore.

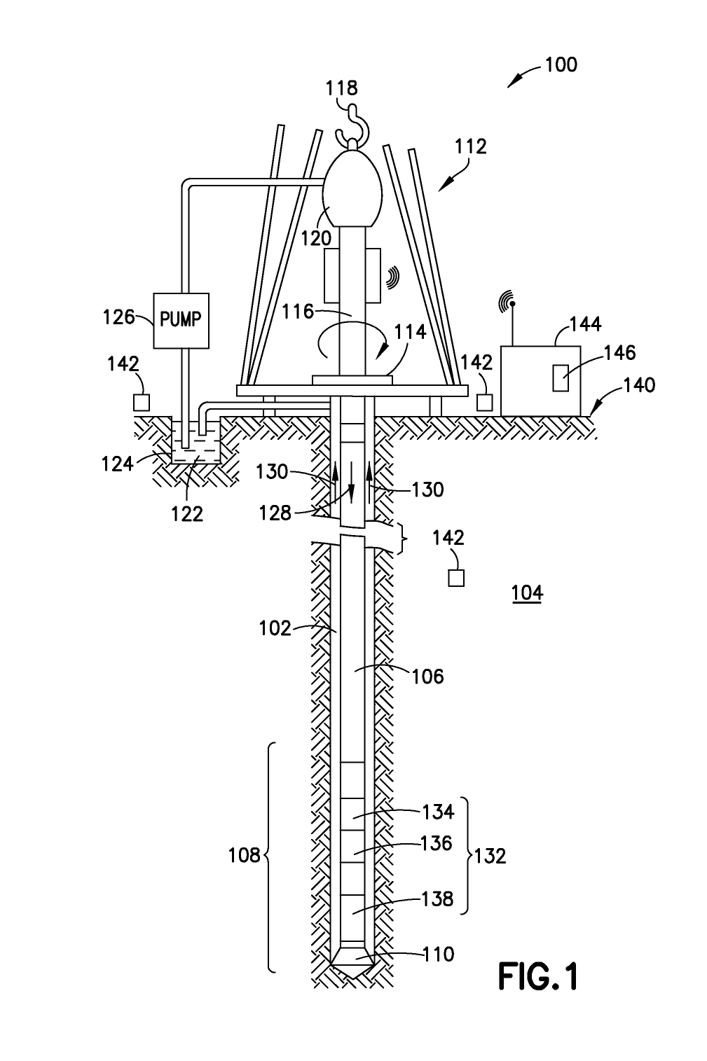

FIG. 1 illustrates a wellsite 100 in which example embodiments of formation analysis and drill steering using lateral wellbores can be employed. Wellsite 100 may be onshore or offshore. In this example system, a borehole 102 is formed in a subsurface formation 104 by rotary drilling in a manner that is well known. In one possible implementation, formation 104 includes a subsurface reservoir of hydrocarbons.

Embodiments of formation analysis and drill steering using lateral wellbores may be employed in association with wellsites 100 where directional drilling has either previously occurred or is currently being conducted. Thus, even though borehole 102 is show as being straight, it may also be curved in any direction or set of directions. Moreover, one or more lateral wells may exist in proximity to borehole 102, and/or one or more sidetrack wellbores may extend from borehole 102.

A drill string 106 is suspended within the borehole 102 and has a bottom hole assembly 108, which includes a drill bit 110 at its lower end. The surface system includes platform and derrick assembly 112 positioned over the borehole 102. The assembly 112 can include a rotary table 114, kelly 116, hook 118 and rotary swivel 120. The drill string 106 is rotated by the rotary table 114 and energized by means (not shown), which engage the kelly 116 at an upper end of the drill string 106. The drill string 106 is suspended from the hook 118, attached to a traveling block (also not shown), through the kelly 116 and a rotary swivel 120, which permits rotation of the drill string 106 relative to the hook 118. As is well known, a top drive system can also be used.

In the example of this embodiment, the surface system can further include drilling fluid or mud 122 stored in a pit 124 formed at the wellsite 100. A pump 126 delivers the drilling fluid 122 to the interior of the drill string 106 via a port in the swivel 120, causing the drilling fluid 122 to flow downwardly through the drill string 106 as indicated by the directional arrow 128. The drilling fluid 122 exits the drill string 106 via ports in the drill bit 110, and then circulates upwardly through the annulus region between the outside of the drill string and the wall of the borehole 104, as indicated by the directional arrows 130. In this well-known manner, the drilling fluid 122 lubricates the drill bit 110 and carries formation cuttings up to the surface as the drilling fluid 122 is returned to the pit 124 for recirculation.

The bottom hole assembly 108 of the illustrated embodiment can include drill bit 110 as well as a variety of equipment 132, including a logging-while-drilling (LWD) module 134, a measuring-while-drilling (MWD) module 136, a steering system 138 (such as a geosteering hub, etc.), a motor, various other tools, etc.

In one possible implementation, the LWD module 134 can be housed in a special type of drill collar, as is known in the art, and can include one or more of a plurality of known types of logging tools (e.g., a nuclear magnetic resonance (NMR system), a directional resistivity system, and/or a sonic logging system). It will also be understood that more than one LWD module 134 and/or MWD module 136 can be employed (e.g. as represented at 138). (References, throughout, to a module at the position of 134 can also mean a module at the position of 138 as well.) The LWD module 134 can include capabilities for measuring, processing, and storing information, as well as for communicating with the surface equipment. LWD module 134 may include transducers and/or sensors for generating and/or sensing/receiving electromagnetic or other waveforms or signals.

The MWD module 136 can also be housed in a special type of drill collar, as is known in the art, and include one or more devices for measuring characteristics of the well environment, such as characteristics of the drill string and drill bit. The MWD module 136 can further include an apparatus (not shown) for generating electrical power to the downhole system. This may include a mud turbine generator powered by the flow of the drilling fluid 122, it being understood that other power and/or battery systems may be employed. The MWD module 136 can include one or more of a variety of measuring devices known in the art including, for example, a weight-on-bit measuring device, a torque measuring device, a vibration measuring device, a shock measuring device, a stick slip measuring device, a direction measuring device, an inclination measuring device, etc. MWD module 136 may also include transducers and/or sensors for generating and/or sensing/receiving electromagnetic or other waveforms or signals.

Various embodiments of the present disclosure are directed to systems and methods for transmitting and/or receiving information (data and/or commands) to and/or from various equipment (including equipment 132) to various areas (including to a surface 140 of wellsite 100). In one implementation, the information can be received by one or more sensors 142. Sensors 142 can be located on, above, or below the surface 140 in a variety of locations. In one possible implementation, placement of sensors 142 can be independent of precise geometrical considerations. Moreover, sensors 142 can be chosen from any sensing technology known in the art, including those capable of measuring electric or magnetic fields, including electrodes (such as stakes), magnetometers, transducers, coils, etc.

In one possible implementation, sensors 142 receive information from adjacent lateral wellbores, which can be utilized to provide control signals to steering system 138 and thereby steer drill bit 110 and any tools associated therewith.

In one possible implementation the information received by the sensors 142 can be monitored, recorded and utilized at a logging and control system 144. Logging and control system 144 can be used with a wide variety of oilfield functionality, including logging while drilling, artificial lift, measuring while drilling, and steering of drill bit 110. In one possible implementation, logging and control system 144 can include a steering control module 146 configured to analyze various types of information, such as, for example, information collected by sensors 142, and formulate commands to instruct steering system 138 to steer drill bit 110 in a desired direction.

All or part of logging and control system 144 can be located at surface 140, below surface 140, proximate to borehole 102, remote from borehole 102, on bottom hole assembly 108, remote from bottom hole assembly 108, or any combination thereof.

### Examples of Drill Steering Using Lateral Wellbores

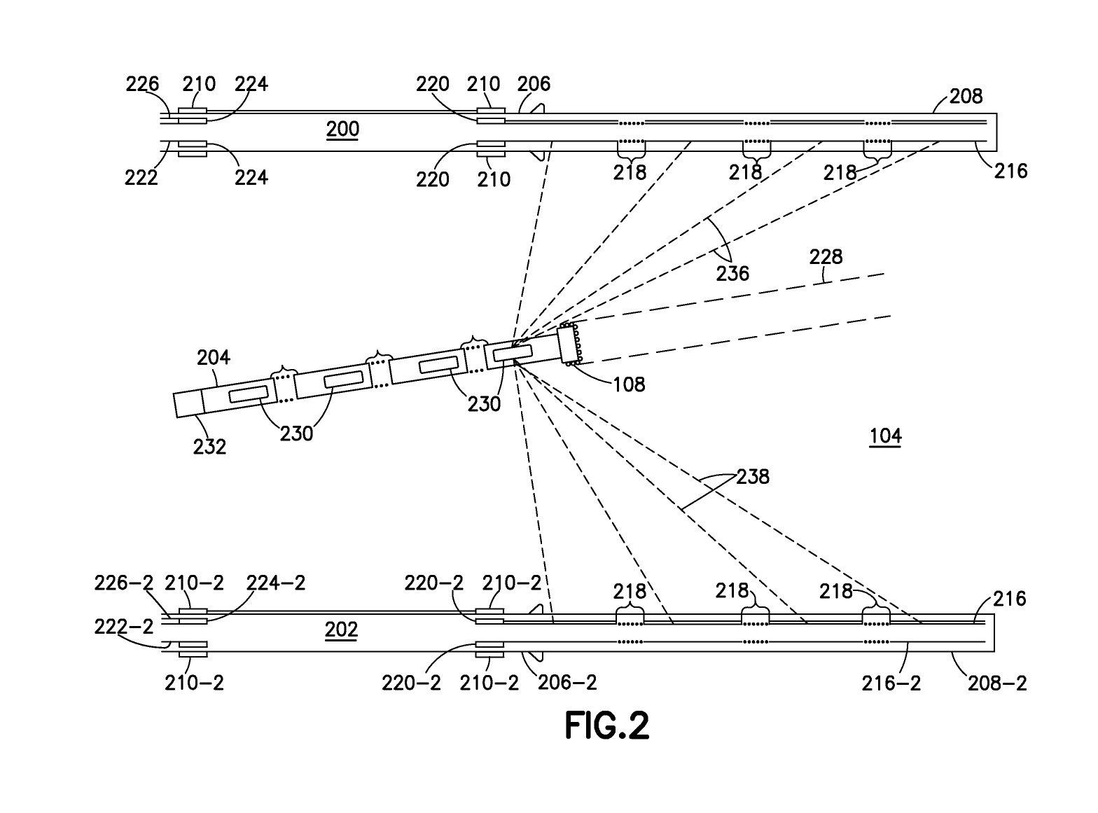

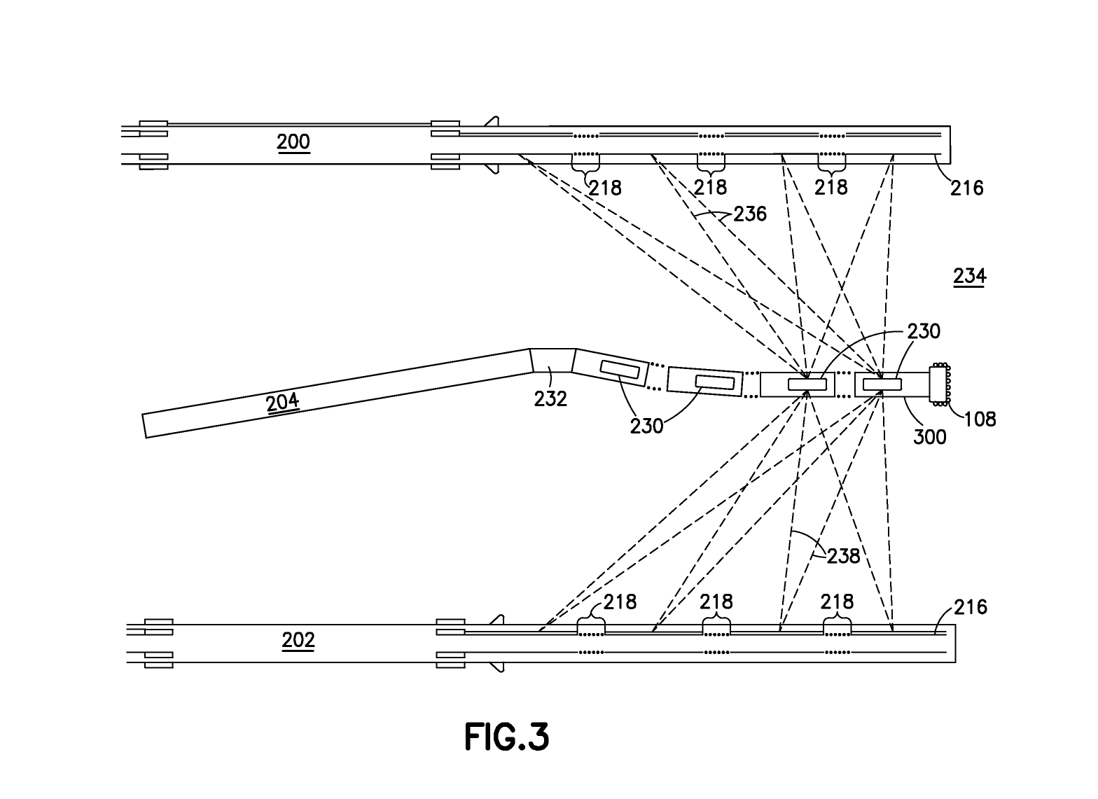

FIGS. 2 and 3 illustrate an example formation analysis and drill steering system that can be used in accordance with various implementations of formation analysis and drill steering using lateral wellbores. As shown, one or more existing lateral wellbores 200 and 202, and a new wellbore 204, which may be undergoing a drilling operation, can be found in reservoir 104.

In one possible implementation, new wellbore 204 may be intended as an “in-fill” well, drilled between or proximate existing wells that previously targeted adjacent areas of formation 104.

Existing wellbores 200, 202 may include cased sections 206, 206-2 and open hole lateral sections 208, 208-2. Although sections 208, 208-2 are illustrated in FIG. 2 as being straight and horizontal, it will be understood that sections 208, 208-2 can curve in any manner possible and can extend in any possible orientation. Additionally, although illustrated as an open hole section (e.g., without a casing), sections 208, 208-2 may be provided with a casing constructed of a material providing transmissivity of a variety of waveforms and/or signal energies that might be useful in analyzing formation 104.

Cased sections 206, 206-2 may include a plurality of female inductive couplers 210, 210-2, which may provide for high power and data transmission across an interface. In one possible implementation, one or more electrical umbilicals mounted on the outside of the casing may connect two or more of the plurality of female inductive couplers 210, 210-2 to each other and/or to surface equipment.

Still referring to FIGS. 2 and 3, one or more transducer arrays 216 can be provided in open hole lateral sections 208, 208-2. In one possible implementation, transducer arrays 216 may include a number of transducers 218, such as electric dipoles, electric quadropoles, electric monopoles, and/or any other transducer technology known in the art.

In one possible implementation, the types and/or numbers of transducers 218 in a transducer array 216 may be determined based on the particular formation 104 and environment in which transducers 218 are to be deployed. For example, if the objective is to drill an infill wellbore to target a low resistivity area in formation 104, an electrical dipole array may be desirable. If, on the other hand, the objective is to target a highly fractured interval or area with high compressibility contrast, such as a gas-bearing zone, then an acoustic transducer array may be employed in addition to, or in lieu of, an electrical dipole array. As will be recognized, transducers 218 associated with any signal/waveform capable of propagating through a target subterranean formation and undergoing at least measurable alteration or attenuation by the formation may be used.

Transducer arrays 216 can be installed/deployed in lateral sections 208, 208-2 and may be powered by any means known in the art, including batteries, electrical cables, induction interfaces, etc. In one possible embodiment, male inductive couplers 220, 220-2 may be placed at a top end of transducer array 216, coupling with female couplers 210, 210-2 and providing power and data connections across the induction interface to and from a surface control system (not shown).

Upper completion tubes 222, 222-2 may be installed in existing lateral wellbores 200, 200-2 and may be provided with male inductive couplings 224, 224-2 at a bottom end of the completion tubes 222, 222-2. Male inductive couplings 224, 224-2 can engage female inductive couplings 210, 210-2 on casings 206, 206-2 and may transmit power and telemetry between surface equipment and downhole transducer arrays 216, 216-2. In one implementation this can be accomplished through electrical cables 226, 226-2.

As noted above, in one possible implementation, one of existing wellbores 200, 202 may be present. Alternately both existing wellbores 200, 202 may be present. In yet another possible embodiment, existing wellbores 200, 202, may be present along with other existing wellbores having their own transducer arrays 216. Moreover, if more existing wellbores than existing wellbore 200 are present, the additional existing wellbores (such as wellbore 202) may be within range of transducer arrays 216 in wellbore 200 (and potentially also within the range of the transducer arrays in each other) but need not be. Moreover, even though wellbores 200 and 202 are drawn as being similar in orientation to one another, they need not be. For example, wellbore 200 may be straight, while wellbore 202 may be curved.

Newly drilled wellbore 204 may be situated adjacent to (but removed from) existing lateral wellbores 200 and 202 and may be undergoing a drilling operation. Newly drilled wellbore 204 may be within range of propagation of the waveforms from transducer arrays 216 intended to be propagated through formation 104.

In one possible implementation, a planned path 228 may be associated with the newly drilled wellbore 204. In one possible embodiment, a direction of planned path 228 can be determined based on geological properties petrophysical properties, etc. associated with formation 104 that may be determined in advance of the drilling operation according to known techniques.

Bottom hole assembly 108, as explained above with regard to FIG. 1, may include drill bit 110 and a series of transducers and electronics 230 (including for example sensors 140) capable of both detecting waveforms generated by transducer arrays 216 in wellbores 200, 202 as well as generating waveforms from within newly drilled well 204. A drill pipe 232 may convey bottom hole assembly 108 into well 204 from surface 140. In one possible implementation, transducers and electronics 230 can include some of all of LWD module 134 and MWD module 136.

Formation 104 may be assumed to have characteristics that affect the propagation of waveform energy, such as that emitted by transducer arrays 216, that are known or constant throughout the section of formation 104 between existing offset lateral wellbores 200 and 202. In one possible implementation, for electrical wavepaths, it may be assumed that the total permissivity or transmissivity of formation 104 is known. Such an assumption may allow ray paths 236 and 238, representing emissions from transducer arrays 216, for example, from both existing offset wellbores 200, 202 to be used as “ranging signals.” Moreover, the influence of formation 104 on the propagation and other characteristics of the waveforms traveling on ray paths 236, 238 may allow the drilling direction to be guided by ray paths 236, 238 from either or both existing offset lateral wells 200, 202.

As will be recognized, the well drilling direction may be redirected from the intended path 228 along a re-directed path 300 (FIG. 3) to an area of interest based upon attenuation of signals travelling on ray paths 236, 238 to maintain a fixed distance between the two existing lateral wellbores 200, 202.

As noted above, open hole sections 208, 208-2 of existing wellbores 200, 202 (also known as “offset lateral wells”) may be open or have casings transparent to waveforms or other energy desired to be propagated through formation 104 by transducer arrays 216. For example, such casings may be made of a non-ferrite material to permit electromagnetic wave propagation. As will be recognized, dipole or transducer arrays utilized in the lateral wellbores 200, 202 may be part of an existing completion or may be installed specifically for the purpose of analyzing surrounding formation characteristics and directing the drilling of a neighboring well towards an area of interest in formation 104.

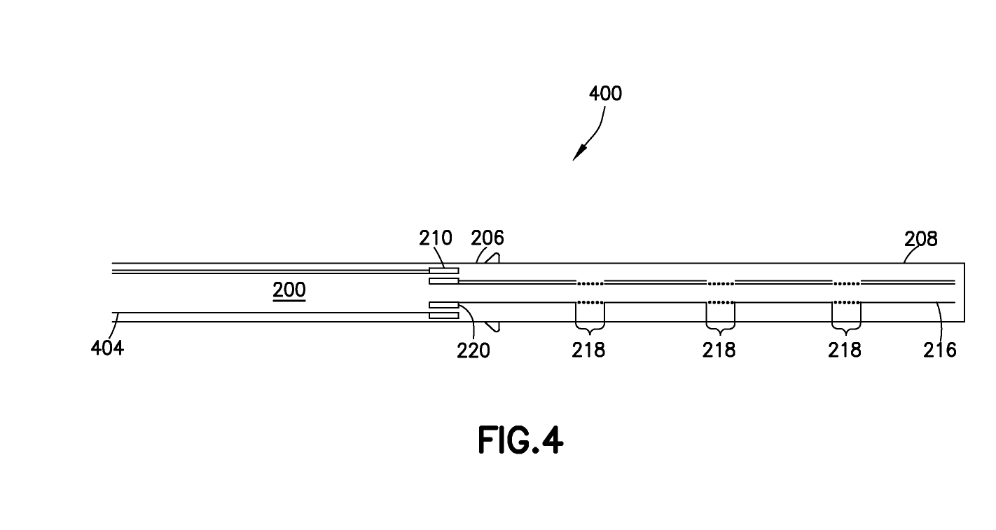

FIG. 4 illustrates an example formation analysis and drill steering system 400 in which transducer array 216, such as a dipole array system, can be installed through existing tubing 404 (or casing) in existing wellbores 200, 202. In one possible implementation, transducer array 216, can be temporarily installed in existing wellbore 200, 202 and quickly removed when desired so that existing wellbore 200, 202 can be employed for other uses.

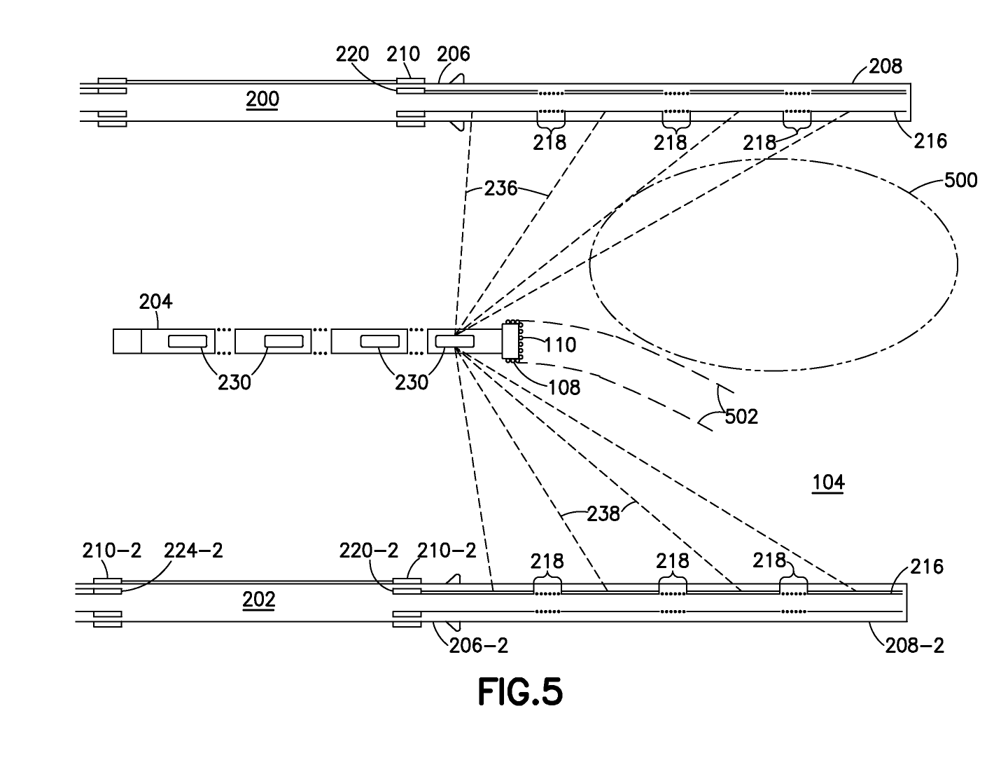

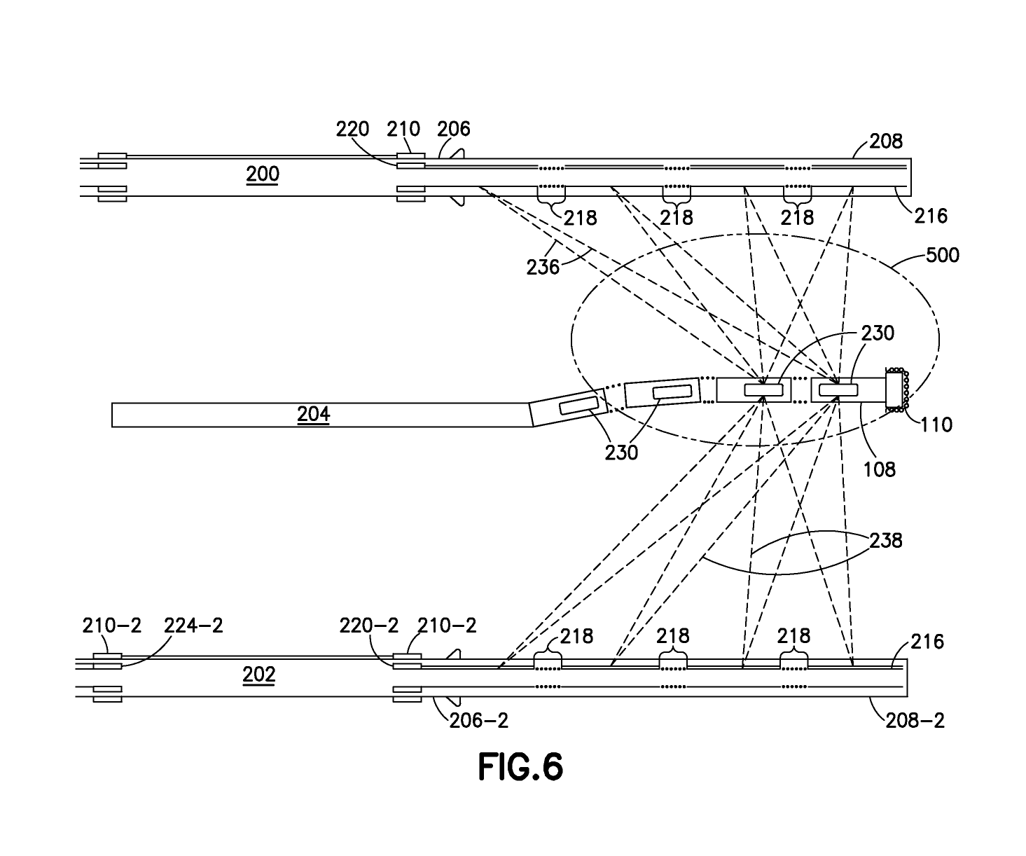

FIGS. 5 and 6 illustrate another possible implementation of formation analysis and drill steering in which lateral wellbores 200, 202 are used to facilitate drill bit 110 towards, or away from, an area of interest 500 in formation 104. In one possible implementation, area of interest 500 can include an area of high resistivity, which in an active water flood, could represent a zone of bypassed oil.

For example, in operation ray paths 236 between transducer arrays 216 on offset well 200 and transducers and electronics 230 on bottom hole assembly 108 can propagate through area of interest 500. This can result in a relative attenuation of the propagated signals/waveforms from transducer array 216 on offset well 200 compared to the signals/waveforms propagated from transducer array 216 on ray paths 238 between offset well 202 and transducers and electronics 230 on bottom hole assembly 108. As will be further described herein, in one possible embodiment, analysis of relative signals/waveforms travelling on various ray paths (such as ray paths 236, 238) can be used to identify differences in the makeup of formation 104 between the existing offset wellbores 200, 202 and new wellbore 204, such that areas of interest, such as area of interest 500, can be located. In one possible implementation, this analysis can include analysis of signal/waveform attenuation, and analysis of assorted waveform characteristics, including electrical field strength, etc.

Such analysis can also be used to steer drill bit 110 in real-time, while drilling, in new wellbore 204 toward target area of interest 500 (such as illustrated in FIG. 6) or away from target area of interest 500 (such as is depicted by path 502 in FIG. 5), as desired

As will be recognized, interpretation of the signals/waveforms emitted by transducer arrays 216 in lateral offset wells 200, 202, can be actively used to evaluate characteristics of formation 104 and geo-steer drill bit 110 in new wellbore 204 undergoing a drilling operation such that drill bit 110 may be steered toward or away from a zone or area of interest 500. In one possible implementation, the characteristics and physics of the signals/waveforms on ray paths, such as ray paths 236, 238, and their alteration due to formation 104 may not be fully inverted. Rather, if formation 104 is considered to be homogenous enough to limit the localized effects on ray paths 236, 238, then the localized transducer information provided by transducer arrays 216 in the existing one or more lateral wellbores 200, 202 may be used to locate areas of interest 500 between lateral wellbores 200, 202 ahead of or in the vicinity of drill bit 110 in active well 204.

In addition to collecting information regarding signals/waveforms propagated between transducer arrays 216 and transducers and electronics 230 on bottom hole assembly 108 as discussed above, information can also be collected by logging while drilling (LWD) module 134 and/or measuring while drilling (MWD) 136 on bottom hole assembly 108. For example, transducers (such as, for example, transducers 218) on logging while drilling (LWD) module 134 and/or measuring while drilling (MWD) module 136 and/or within transducers and electronics 230 can be used to generate and/or transmit various signals/waveforms into formation 104 from active well 204 being drilled. These signals/waveforms can be detected by transducer arrays 216 deployed within the one or more existing lateral wellbores 200, 202. This can facilitate the creation of additional localized waveform/signal propagation data, which may be used to obtain an improved delineation of any localized formation characteristics, enabling more accurate targeting (or avoidance) of areas of interest 500 within formation 104.

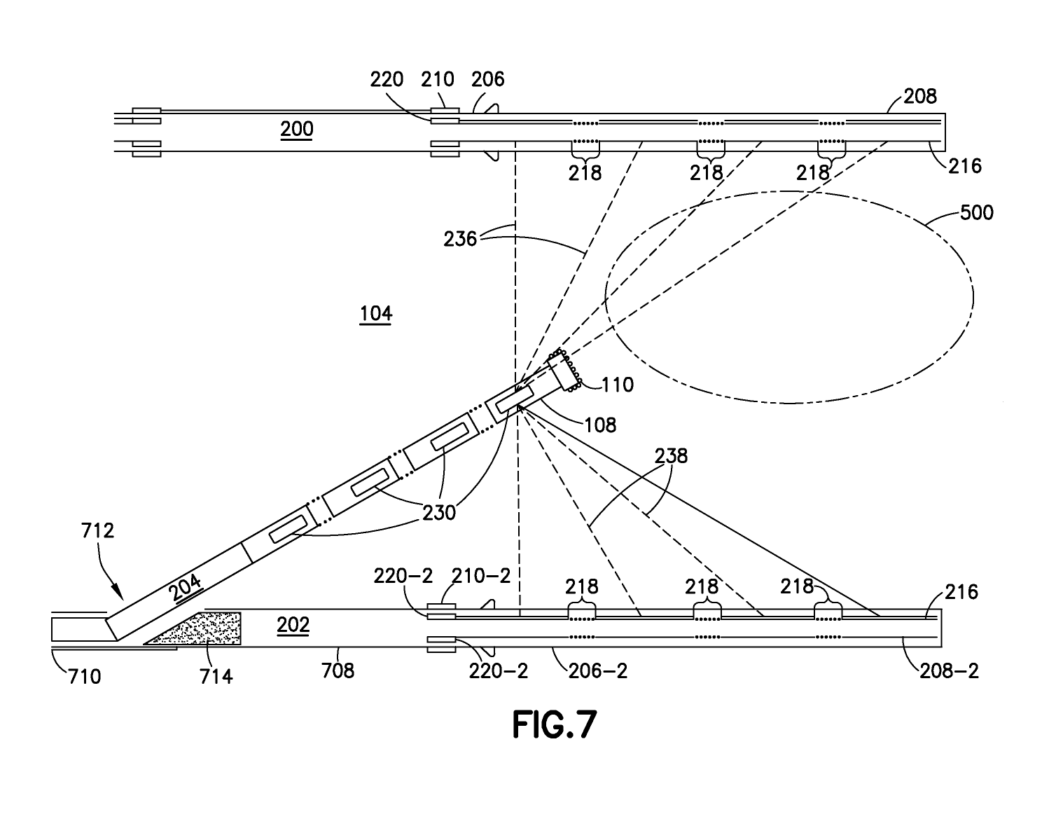

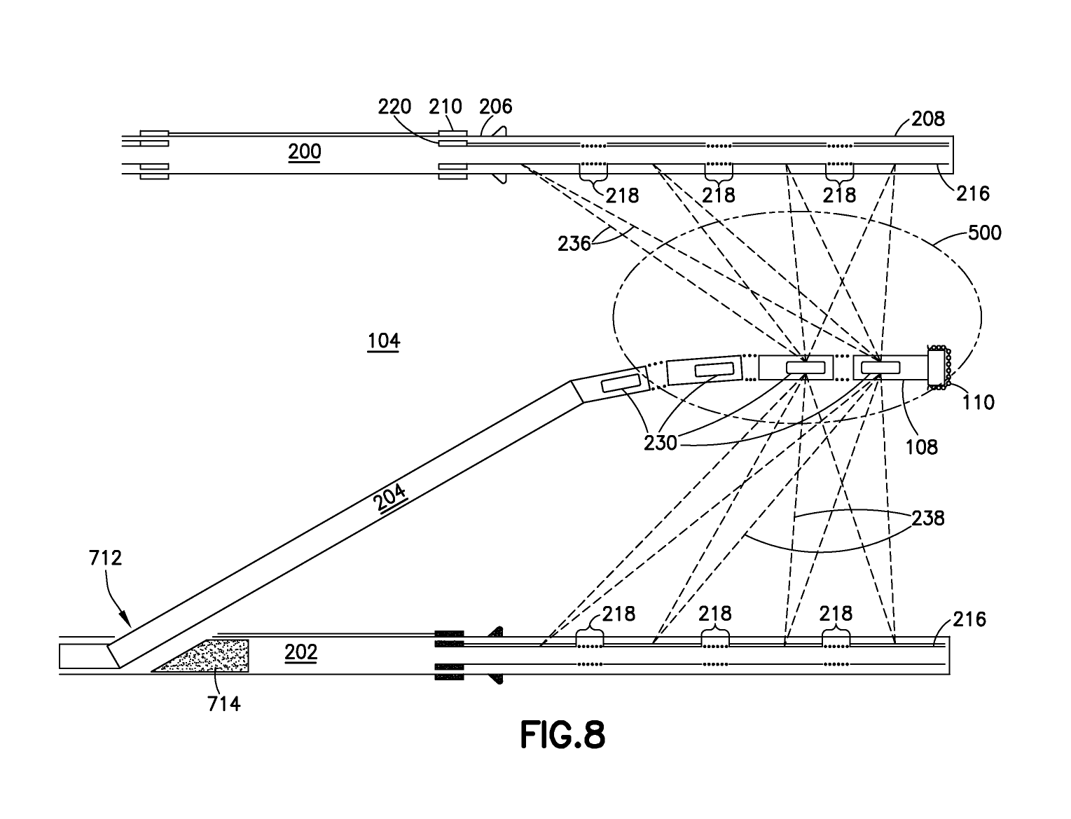

FIGS. 7 and 8 illustrate another possible implementation of formation analysis and drill steering using lateral wellbores in which a lateral wellbore created within the same well as a primary/active well being drilled can be utilized.

As illustrated, in one possible implementation, lateral wellbore 202 is created in the same well as well 204 being drilled. A cable 710 for power and data transmission from inductive coupling 220-2 to surface equipment is oriented such that it is away from a junction window 712, which permits new wellbore 204 to be drilled as a branch from wellbore 202. In one possible implementation, a milling assembly may be utilized in wellbore 202 to mill junction window 712. A whipstock 714 may be utilized in wellbore 202 to orient the milling assembly to mill junction window 712 in a casing in wellbore 202.

In operation, signals/waveforms propagated between transducer array 216 in wellbore 202 and transducers and electronics 230 on bottomhole assembly 108, can be used to collect information regarding formation 104 in any of the manners described herein. This information can be used to steer drill bit 110, in any direction desirable, while drill bit 110 is in operation, in any manner described herein. In one possible implementation this includes steering drill bit 110 toward an area of interest 500, such as is illustrated in FIG. 7.

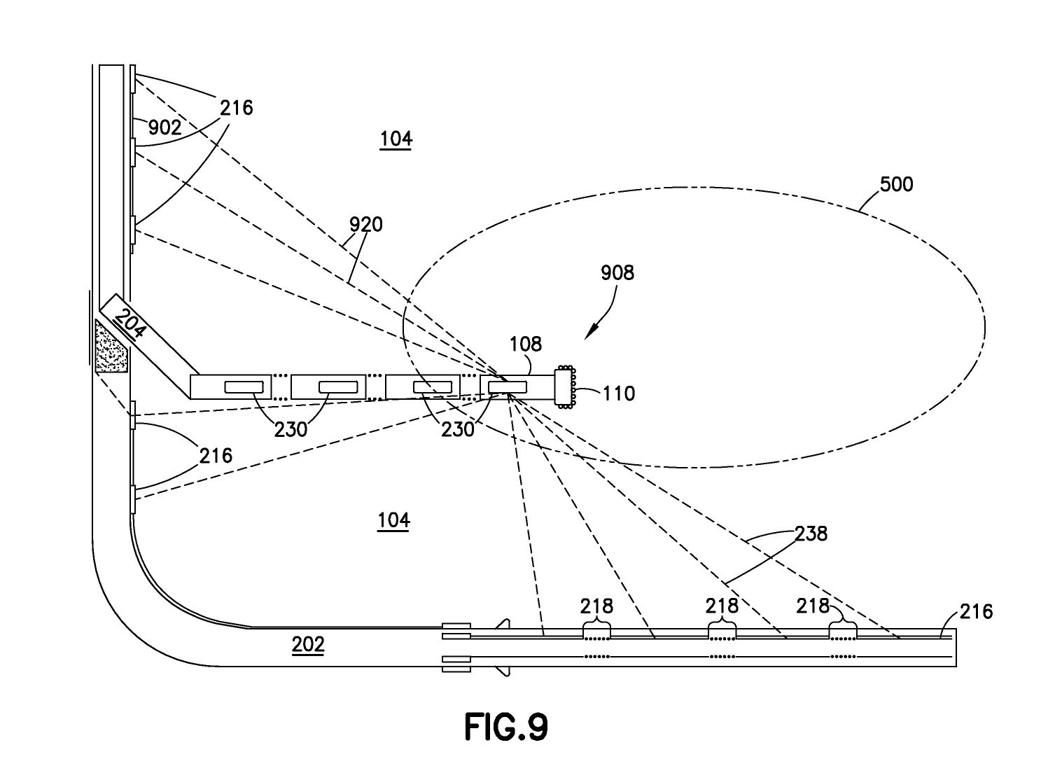

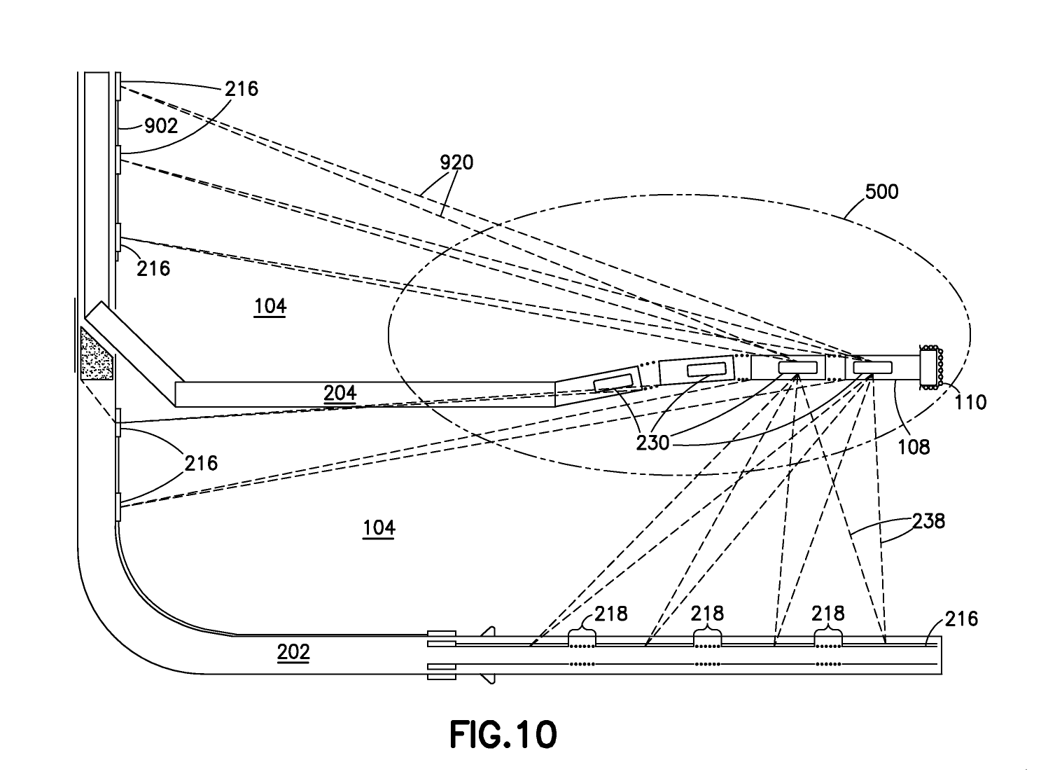

FIGS. 9 and 10 illustrate yet another possible implementation of formation analysis and drill steering system in which a lateral wellbore, such as lateral wellbore 202, was previously created in the same well as well 204 being drilled. In this implementation, one or more transducer arrays 216 can be mounted on various points on or near a casing 902 of the existing wellbore from which new well 204 is being drilled. In one possible implementation, the one or more transducer arrays 216 can be mounted uphole from an active drilling region 908. It will also be understood that the one or more transducer arrays 216 could alternately, or additionally, be mounted at other areas of casing 902, including downhole from active drilling region 908.

If desired, additional transducer arrays 216 can be placed in existing lateral bore 202 in the same manner described above. Ray lines 920 depict a direction of propagation of signals/waveforms from transducer arrays 216 on casing 902 through formation 104 to transducers and electronics 230 in new well 204.

In operation, information regarding formation 104 can be collected in any of the manners described in this disclosure. This information can be used to steer drill bit 110, in any direction desirable, while drill bit 110 is in operation, in any manner as described herein. In one possible implementation this includes steering drill bit 110 through an area of interest 500, such as is illustrated in FIG. 9, or away from an area of interest 500 as shown in FIG. 5.

It will be noted that the examples above in FIGS. 2-9 can be combined in any manner possible, with as many transducer arrays 216 and as many lateral wells as desired. For example, the system shown in FIG. 9 can include one or more additional existing lateral wells (such as wells 200, 202) with additional transducers arrays 216 in communication with transducers and electronics 230. Moreover, as noted above, communication between transducer arrays 716 and transducers and electronics 230 can occur in any ways possible. For example, transducers and electronics 230 can receive signals/waveforms from transducer arrays 216. Similarly, transducer arrays 216 can receive signals/waveforms from transducers and electronics 230. Moreover, two way communication can occur between transducer arrays 716 and transducers and electronics 230.

### Example Analysis for Drill Steering

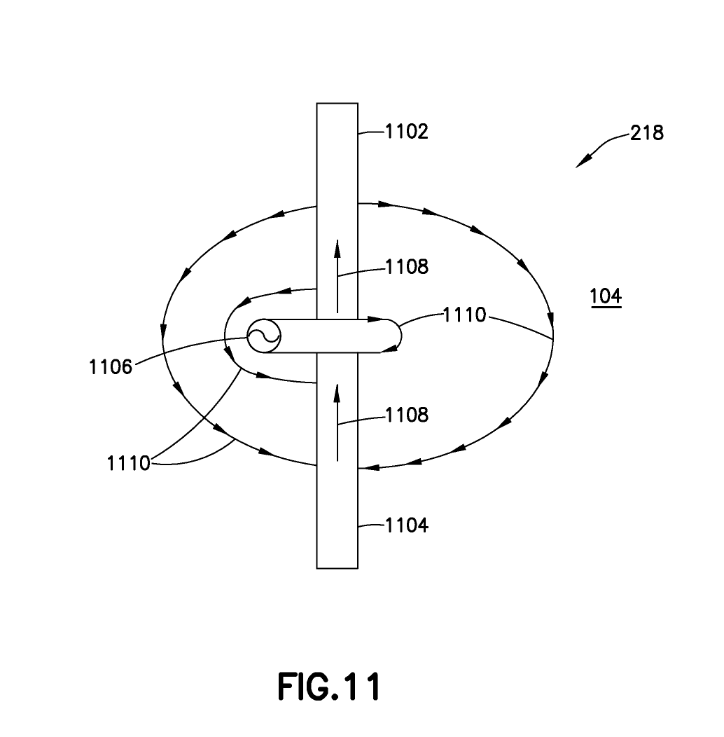

FIG. 11 illustrates an example transducer 218 in accordance with various embodiments of formation analysis and drill steering using lateral wellbores. As illustrated, transducer 218 is an electric dipole, though as noted above, transducer 218 can comprise any other transducing technology known in the art.

Transducer 218 can be formed by connecting two conductive rods 1102 and 1104 to two ports of a source 1106, such as an AC electric generator. Source 1106 can take any form known in the art, and can include, for example, a constant current, constant voltage and/or a constant power generator. As shown, current 1108 closes the circuit in FIG. 11 by running from first conductive rod 1102, through formation 104 along lines 1110 to second conductive rod 1104. The result of this circuit is the creation of an electric field E.

In one possible implementation, electric filed, E, at distances, r, from transducer 218 can be given by:

$$\vec{E} = \hat{θ} \frac{j k \sqrt{\frac{μ}{{ɛ}^{*}}} {e}^{- j kr}}{8 π r} I ( {h}_{1} + {h}_{2} ) sin θ \qquad ( 1 )$$

wherein j is the imaginary number, u is the magnetic permeability of formation 104, ε* is the permittivity of formation 104, which can be a complex number if formation 104 is conductive, I is the current 1108 injected into the circuit by source 1106, and h₁ and h₂ are the lengths of conductive rods 1102 and 1104, respectively. In one possible implementation, propagation constant k can be given by,

$$k = \frac{2 π f}{c} \sqrt{{μɛ}^{*}} = \frac{2 π f}{c} \sqrt{μ ( {ɛ}^{′} + j \frac{σ}{2 π {fɛ}_{0}} )} \qquad ( 2 )$$

wherein f is the frequency, c is the speed of light in a vacuum, and ε* is the complex permittivity, which is a combination of real permittivity, ε′, and an imaginary part which in itself is a function of conductivity, σ, and permittivity of free space ε₀.

As Eq. 1 shows, the intensity of the electric field E can be directly proportional to the lengths of the two conductive bars 1102, 1104. Thus, if measurements of the electric field E at large distances from conductive bars 1102, 1104 are desired, h₁ and h₂ may be chosen to be a proportionate length to enable the radiation from transducer 218 to reach distant targets through formation 104.

In one possible implementation, transducer 218 can be in one well (such as well 200, 202) and transducers and electronics 230 can be in well 204 a few kilometers away, while still being in communication through formation 104.

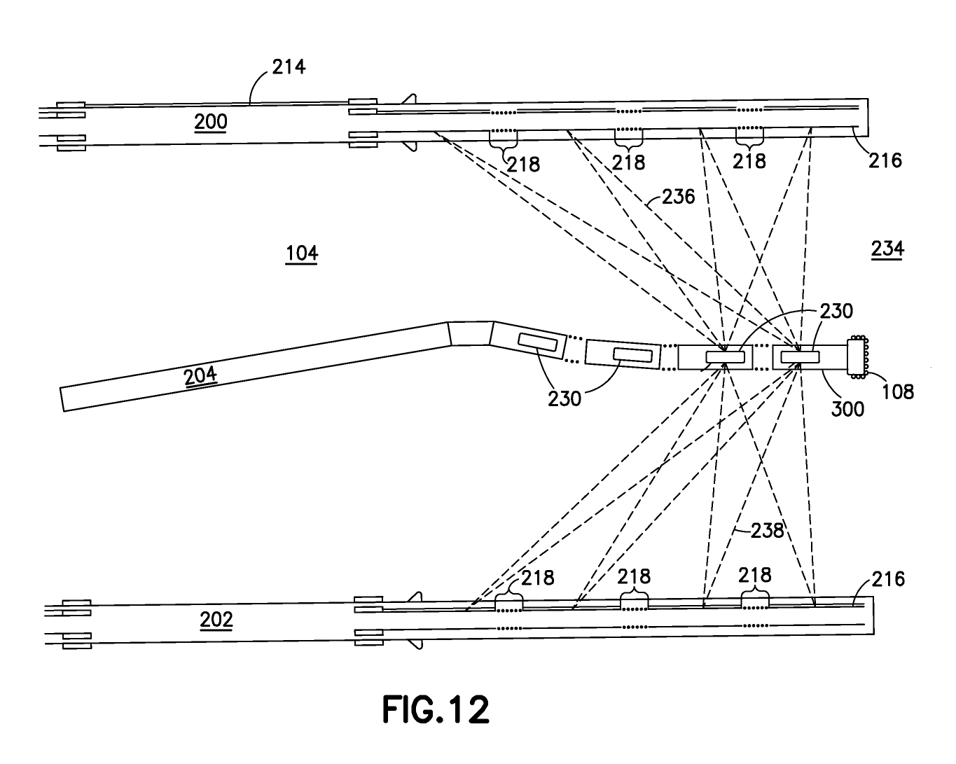

FIG. 12 illustrates the operation of transducer 218 in accordance with various embodiments of formation analysis and drill steering using lateral wellbores. As shown, at least one transducer 218 may be positioned in lateral well 200, 202, and at least one transducer may be positioned in transducers and electronics 230 in side tracked 204.

In one possible embodiment, wells 200, 202, 204, may be drilled to a length of 10,000 meters or more, thus providing ample space to place potentially long rods 1102, 1104 inside wells 200, 202, 204.

In one possible embodiment, it may be desired to drill well 204 in a predetermined geometric relationship to one or more of wells 200, 202. The geometric relationship may be a parallel relationship, or a complex well path. As Eq. 1 above shows, the intensity of electric field E of transducer 218 is proportional to the strength of current 1108 injected into rods 1102, 1104. Thus, in one possible implementation, it may be desirable to place one or more transducers 218 comprising transmitter dipoles, which may have a large power demand, as part of the drill string in well 204, while having receivers in transducer arrays 216 in wells 200, 202. In one possible implementation, the principle of reciprocity provides that the measured signal is the same if the roles of transmitter (T) and receiver (R) antennas are reversed in transducers 218 and transducers and electronics 230.

Bottom hole assembly 108 may include drill bit 110, at least one dipole antenna, steering system 138 (such as a geosteering subassembly) and possibly other LWD and/or MWD tools (not shown).

In one possible implementation, in order to drill well 204 in a desired location, at various points in time, the distance and orientation of well 204 and/or drill 110 relative to a primary/mother well of interest (such as wellbores 200, 202) may be determined and compared with a desired distance and orientation to determine whether or not any alteration is needed. If well 204 and/or drill 110 is not on track, then a steering command can be formulated and transmitted by steering control module 146 to steering system 138 to change the drilling direction and alter the drilling path of well 204 using any directional drilling techniques and/or technologies known in the art.

For simplicity, the following example is modeled based on a planar geometry—i.e. well 204 and its reference lateral well (such as 200 and/or 202) are in the same plane. It will be recognized, however, that the two-dimensional analysis described herein may be readily extended to three dimensions and the case in which well 204 and its reference lateral well are not in the same plane. In one possible implementation, the two-dimensional analysis described herein may be used to process measurements using any computer program as known in the art.

Eq. 1 can be rearranged as:

$$E = [ I ( {h}_{1} + {h}_{2} ) \frac{k \sqrt{\frac{μ}{{ɛ}^{*}}}}{8 π} ] j \frac{{e}^{- j kr}}{r} sin θ = {E}_{0} j \frac{{e}^{- j kr}}{r} sin θ \qquad ( 3 )$$

where the magnitude of the electric field E is considered and the terms are reorganized so that E₀ can be influenced by the design of transducer 218. The spatially dependent terms can be kept explicit and separated from E₀. In one possible implementation, Eq. 3 can be further expanded:

$$E = {E}_{0} \frac{sin ( kr ) + j cos ( kr )}{r} sin θ \qquad ( 4 )$$

wherein E₀ can be independent of a distance and angle between the two antennas as given by:

$${E}_{0} = ( \frac{1}{8 π} I ( {h}_{1} + {h}_{2} ) k \sqrt{\frac{μ}{{ɛ}^{*}}} ) = ( \frac{1}{8 π} I ( {h}_{1} + {h}_{2} ) \frac{2 π f}{c} \sqrt{μ} ) \qquad ( 4 A )$$

In one possible embodiment, solution of Eq. 4A can be simplified when a tool's frequency(ies) of operation is known, and lengths of the two electrodes and the injected current are known. In addition, in one possible aspect, it can be assumed that magnetic permeability of the formation is equal to that of free space. Thus, in one possible embodiment, E₀ is known.

As Equation (4) shows, the spatial variation of the electric field can include a (1/r) decay and a sinusoidal oscillation with θ and kr as variables. Thus, the field intensity can decrease with 1/r and at the same time can be modulated by the sinusoidal terms that are associated with r, both through its explicit association with kr and the geometrical relationship between the angle θ and r.

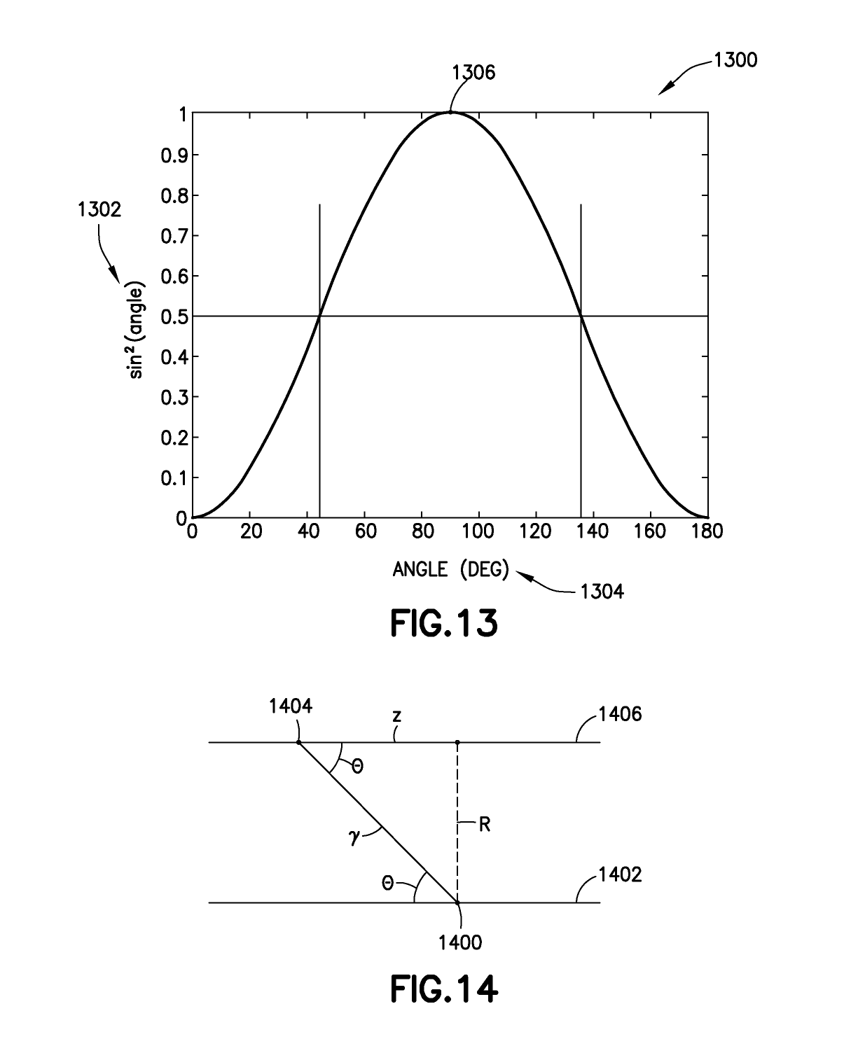

FIG. 13 illustrates an example plot 1300 of the variation of signal strength 1302 with angle 1304 to an electric dipole that can be used in accordance with various implementations of formation analysis and drill steering using lateral wellbores. As illustrated, in one possible implementation, the sinusoidally varying terms in Eq. 4 may not be of the same magnitude. Although angle θ can vary from 0 to 180 degrees, since transmitter and receiver antennas of transducers 218 and transducers and electronics 230 are in different wells (200, 202, 204) the transmitter and receiver antennas may be separated by a large distance, which can lead to a weak or non existing signal. The reason for this is: 1) the distance r increases, and 2) sin (θ) decreases. Both of these factors contribute to signal reduction and their combination can lead to possible sin²(θ) dependence as discussed below.

In one possible implementation to get a cutoff of sin²(θ)>=0.5, θ can be between 45 and 135 degrees. FIG. 13 also shows that a maximum 1306 of sin²(θ) can be found at θ=90 degrees.

In one possible embodiment, the sinusoidal terms involving kr and k may be determined by Equation (2) above. Assuming f=1 Khz, ε of formation=1000, u=1, and c=3*10̂8 m/sec, k can be calculated to be 6.6×10̂−4. When this is combined with r of roughly 1000 m, the product is 0.66 degrees. Thus, the sin(kr) and cos(kr) terms can be approximately zero and one, respectively. This can simplify Equation 4 to:

$$E = j {E}_{0} \frac{sin θ}{r} \qquad ( 5 )$$

In accordance with Equation (5), in one possible implementation, material properties can influence E₀ and have an influence on the angular dependence of the signal from transducer 218.

FIG. 14 illustrates an example ray diagram that can be used with various implementations of formation analysis and drill steering using lateral wellbores. As shown, one antenna 1400 (transmitter or receiver) of a transducer 218 is located in a well (such as wellbores 200, 202) with trajectory 1402, while another antenna 1404 (transmitter or receiver) of another transducer 218 is located in another well (such as well 204) with trajectory 1406. The distance between the antennas 1400, 1404 is r and the angle between antennas 1400, 1404 is θ. In one possible embodiment, for the sake of demonstration, the two wells and the two antennas 1402, 1402 can be assumed to be in the same plane. In other possible implementations, antennas 1402, 1402 can be in different planes.

The perpendicular distance between the wells is R.

In one possible implementation, by using FIGS. 13 and 14, one of the parameters (r or θ) can be solved for in terms of the other and substituted in Equation 5, leading to:

$$\begin{matrix}E = j {E}_{0} \frac{R}{{r}^{2}} and & ( 6 a ) \\ E = j {E}_{0} \frac{{sin}^{2} θ}{R} & ( 6 b )\end{matrix}$$

In one possible example, measurements can be performed as one of the antennas, 1404 for example, moves along trajectory 1406. Initially, the measurement values can be monitored until a strong signal, (including a possible maximum signal) is reached. According to Eq. 6b, a position of antenna 1404 that yields a strong (including potentially a maximum) signal corresponds to θ being equal to 90-degrees. Also, at this position, r=R so that Equation (6a) can be used to solve for R since E₀ can be known. Moreover, since the trajectory 1406 of wellbore 204 may not be drilled yet, while antenna 1404 is in its current location, antenna 1400 can be moved to a point until the signal is increased/maximized, at this point, θ=90 and r=R.

In one possible embodiment, the factor k in Eq. 4 can include formation properties (ε*) which can be calculated when θ is around 90 degrees. In one possible implementation, when θ is close to but different from 90 degrees, FIG. 13 can be used to calculate θ. This can be done by first finding the 90 degree location, then going backwards or forward by a distance z from the 90 degree location and using the measured signal E(z). From z and R the angle θ can be calculated and used in Eq. 4 to determine k.

In one possible aspect, this point can also be used to establish a base while trajectory 1406 of well 204 is drilled. The signal can again be compared with the case of θ=90 degrees, and new θ and r (and perhaps R) can be calculated. If the angle and/or the distance between the two trajectories 1402, 1406 thus measured do not meet the planned well path, a command can be sent by steering control module 146 to steering system 138 to change a direction of drilling of well 204 until a desired trajectory is achieved. As trajectory 1406 extends further away from the base point, the signal level decreases. This can be compensated by occasionally moving the antenna 1400 to a new location where a new θ=90 degrees condition is met and the process continues.

The example embodiment described above can involve one antenna 1400 in trajectory 1402 and one antenna 1404 in trajectory 1406. In alternate examples, there may be multiple antennas in both trajectories 1402, 1406 and multiple combinations of obtainable T-R measurements. In one possible implementation, the resulting measurements can be used to determine r and θ at each point along trajectory 1406 to make a steering decision. It will be recognized that T-R combinations can introduce one unknown (such as sin (θ)) (see Eq. 6) but can also provide a complex signal with real and imaginary values (for example, 2 measurements). As a result, in one possible embodiment, it can be possible to solve for unknowns simultaneously and determine the spatial parameters of the signal and more, as discussed below. In this arrangement, antenna 1400 can remain stationary, and the combination of other antennas located at various locations in trajectory 1402 can be used to achieve the same goal.

In one possible implementation, array of transducers 216 forming antenna 1402 may be formed using casing or completion tubing in preexisting lateral wells 200 and/or 202. For example, while casing well 200, 202 the casing tubing can be isolated in selected locations along well 200, 202 to form transducers 218 comprising, for instance, electric dipoles for use in accordance with the teachings herein. In such a case, transducers 218 in the preexisting well 200, 202 can be stationary and transducers 218 in the actively drilled well 204 can be moved.

In one possible implementation, the electrical properties u and ε can be constant; i.e., the formation can be treated as a homogenous medium. In other possible implementations, the properties of formation 104 may not be constant. This may be the result of geological differences such as an extra formation layer, or may be caused by by-passed oil, for example. In one possible implementation, the permittivity of formation 104 may be dependent on the water saturation in the pore space and, if more oil exists in the pore space in some regions, it may imply less water and thus higher formation resistivity. If the extra formation layer does not include oil (a shale layer for example), it may be of interest to avoid that layer, in which case techniques such as geosteering may be utilized to appropriately re-route drill bit 110.

On the other hand, if a part of formation 104 includes by passed oil, the steering system 138 assembly may be directed by steering control module 146 to cause bit 110 to drill towards that part of formation 104.

### Example Methods

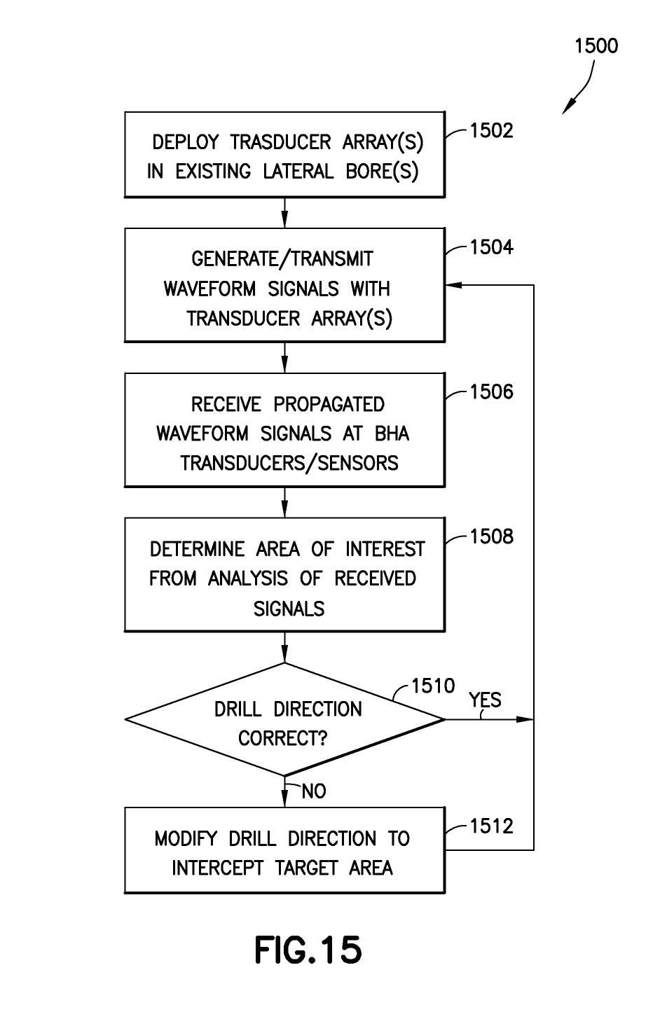

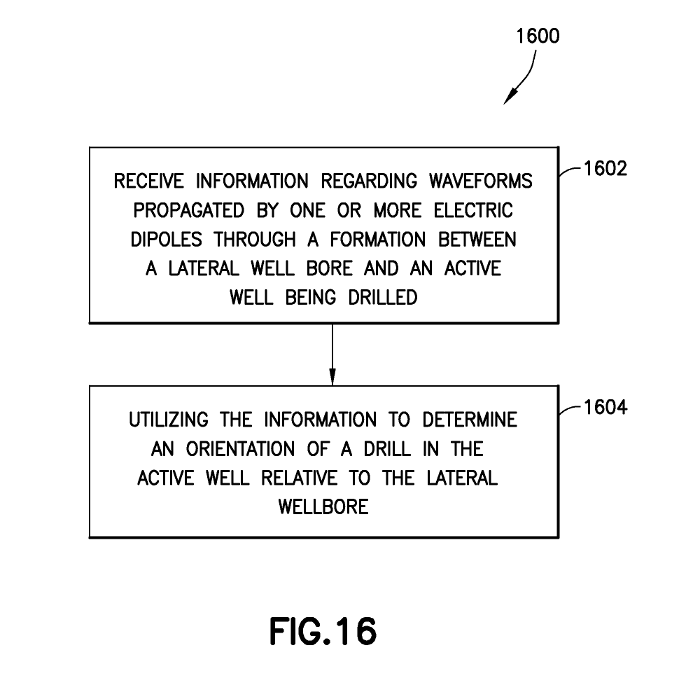

FIGS. 15 and 16 illustrate example methods for implementing aspects of formation analysis and drill bit steering using lateral wellbores. The methods are illustrated as a collection of blocks and other elements in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. In the context of software, the blocks and other elements can represent computer instructions that, when executed by one or more processors, perform the recited operations.

FIG. 15 illustrates an example method 1500 that can be used with embodiments of formation analysis and drill steering using lateral wellbores. At block 1502, one or more transducer arrays (such as, for example, transducer arrays 216) are deployed in one or more existing, respective lateral wellbores (such as existing wellbores 200, 202). As described above, such transducer arrays may also include transducers on an active or primary drill string in a wellbore (such as wellbores 204) that is undergoing a drilling operation. Moreover, transducer arrays may be deployed on one or more wellbore casings, (such as wellbore casings 902) instead of, or in addition to, being deployed within a drill string.

At block 1504, waveform signals are generated and transmitted using the transducer arrays and propagated into a formation, such as formation 104.

At block 1506, the propagated waveform signals are received at transducers or sensors (such as transducers and electronics 230) in a bottom hole assembly (BHA), such as bottom hole assembly 108.

At block 1508, one or more areas of interest, such as area of interest 500, are determined from analysis of the received propagated waveform signals, which will have been influenced by the surrounding formation between the lateral wellbore transducer arrays and the primary/active wellbore being drilled.

At block 1510, a decision is made as to whether or not the drill direction is correct, that is, if the direction of a drill bit, such as drill bit 110, is on target to intercept (or avoid) the area of interest (as desired), or is in a desired orientation relative to a lateral wellbore.

If it isn't, a modification to the drill direction is undertaken at block 1512, such as by sending an appropriate control signal to a drill steering device, such as steering system 138, such that the direction of the drill changes to a desired direction.

On the other hand, if at block 1510 it is determined that the drill is on target, no direction modification is performed. In one possible implementation, method 1500 can return to 1504 to repeat blocks 1504 to 1510.

FIG. 16 illustrates an example method 1600 that can be used with embodiments of formation analysis and drill steering using lateral wellbores.

At block 1602, information is received regarding waveforms propagated by one or more electric dipoles through a formation between a lateral wellbore (such as wellbores 200, 202) and an active well being drilled (such as well 204). For example in one possible embodiment, the waveforms can be transmitted by transducers in the lateral wellbore (such as 218) and received by transducers and electronics (such as transducers and electronics 230) in the active well being drilled. In another possible implementation, the waveforms can be transmitted by transducers and electronics and received by transducers. In yet another possible implementation, communication of waveforms can occur in any direction between the lateral wellbore and the active well being drilled.

At block 1604 the information from block 1602 is utilized to determine an orientation of a drill in the active well relative to the lateral wellbore. In one possible implementation this is done by a steering control module (such as steering control module 146).

For example, the relationship between a distance r between the lateral wellbore and the active well, as well as an angle θ between the lateral wellbore and the active well, as represented in Eq. 5

$$E = j {E}_{0} \frac{sin θ}{r} \qquad ( 5 )$$

can be examined, and the orientation of the drill relative to the lateral wellbore can be manipulated through alteration of one or more of r and θ. In one possible implementation, the steering control module can issue instructions to a steering system (such as steering system 138) to effect changes in r and/or θ to move the drill in a desired direction.

### Example Computing Device

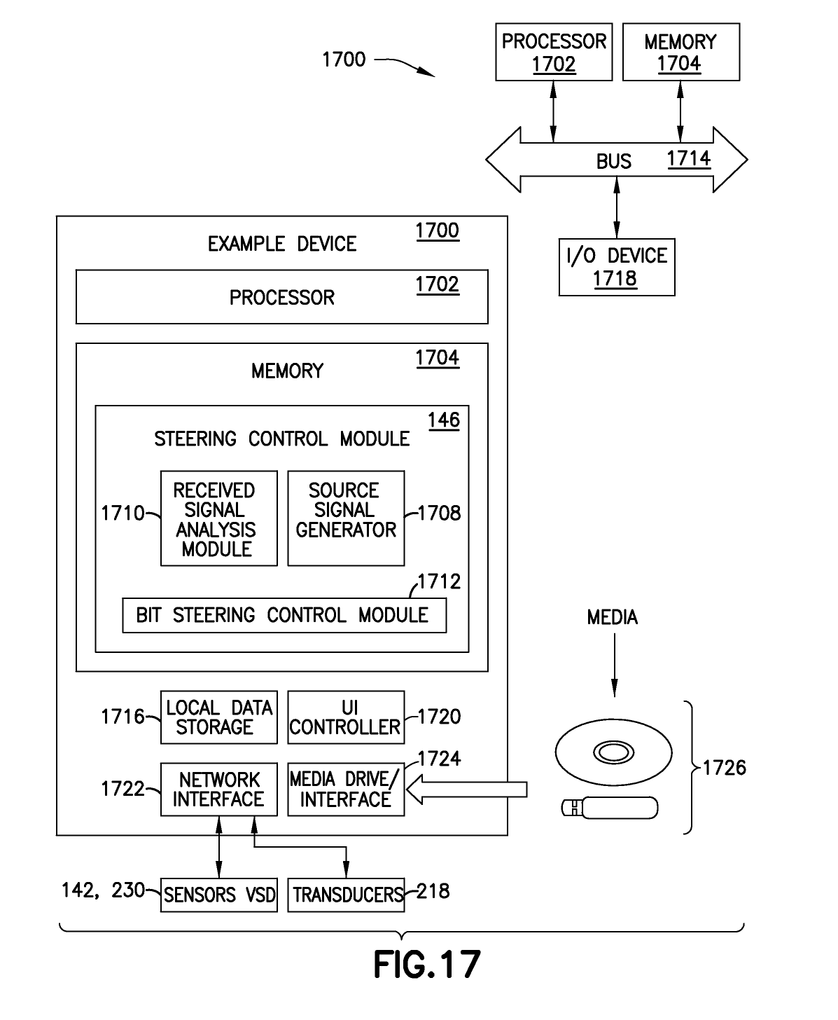

FIG. 17 illustrates an example device 1700, with a processor 1702 and memory 1704 for hosting steering control module 146 configured to implement various embodiments of formation analysis and drill bit steering using lateral wellbores as discussed herein. Steering control module 146 may include a source signal generator module 1708, for causing one or more transducers 218 to generate source signals or waveforms to be propagated through formation 104. Steering control module 146 may also include a received signal analysis module 1710 for analyzing received signals representing waveforms or signals after propagation through formation 104 and as received by transducers and electronics 230 located on the drill string or elsewhere. Memory 1704 may also host a drill bit steering control module 1712, and one or more databases. Memory 1704 can include one or more forms of volatile data storage media such as random access memory (RAM)), and/or one or more forms of nonvolatile storage media (such as read-only memory (ROM), flash memory, and so forth).

Device 1700 is merely one example of a special purpose computing device or programmable device, and is not intended to suggest any limitation as to scope of use or functionality of device 1700 and/or its possible architectures. For example, device 1700 can comprise one or more computing devices, programmable logic controllers (PLCs), etc.

Further, device 1700 should not be interpreted as having any dependency relating to one or a combination of components illustrated in device 1700. For example, device 1700 may include one or more of a computer, such as a laptop computer, a desktop computer, a mainframe computer, etc., or any combination or accumulation thereof.

Device 1700 can also include a bus 1714 configured to allow various components and devices, such as processors 1702, memory 1704, and local data storage 1716, among other components, to communicate with each other.

Bus 1714 can include one or more of any of several types of bus structures, including a memory bus or memory controller, a peripheral bus, an accelerated graphics port, and a processor or local bus using any of a variety of bus architectures. Bus 1714 can also include wired and/or wireless buses.

Local data storage 1716 can include fixed media (e.g., RAM, ROM, a fixed hard drive, etc.) as well as removable media (e.g., a flash memory drive, a removable hard drive, optical disks, magnetic disks, and so forth).

An input/output (I/O) device 1718 may also communicate via a user interface (UI) controller 1720, which may connect with I/O device 1718 either directly or through bus 1714.

In one possible implementation, a network interface 1722 may communicate outside of device 1700 via a connected network, and in some implementations may communicate with hardware, such as one or more sensors 142, transducers 218, and transducers and electronics 230, for generating or receiving waveform signals.

In one possible embodiment, sensors 142, transducers and electronics 230, and transducers 218 may communicate with system 1700 as input/output devices 1718 via bus 1714, such as via a USB port, for example.

A media drive/interface 1724 can accept removable tangible media 1726, such as flash drives, optical disks, removable hard drives, software products, etc. In one possible implementation, logic, computing instructions, and/or software programs comprising elements of the steering control module 146, source signal generator 1708, received signal analysis module 1710, and bit steering control module 1712 may reside on removable media 1726 readable by media drive/interface 1724.

In one possible embodiment, input/output devices 1718 can allow a user to enter commands and information to device 1700, and also allow information to be presented to the user and/or other components or devices. Examples of input devices include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of steering control module 146, source signal generator 1708, received signal analysis module 1710 and bit steering control module 1712 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A drill steering system, comprising:
a steering control module including:
a received signal analysis module configured to analyze transducer signals propagated through a formation between a lateral wellbore and an active well undergoing a drilling operation; and wherein the steering control module is configured to utilize the analyzed transducer signals to direct a steering system to steer a drill in the active well in a desired direction.

2. The drill steering system of claim 1, further comprising:
a source signal generator configured to instruct one or more transducer arrays associated with the lateral wellbore to generate a first set of transducer signals to be propagated through the formation.

3. The drill steering system of claim 1, further comprising a source signal generator configured to instruct one or more transducer arrays associated with the active well to generate a second set of transducer signals to be propagated through the formation.

4. The drill steering system of claim 1, wherein the steering control module is further configured to determine an area of interest in a formation based upon the analyzed transducer signals.

5. The system of claim 4, wherein the steering control module is configured to determine the area of interest based upon electromagnetic field strength represented in the analyzed transducer signals.

6. The drill steering system of claim 4, further comprising a bit steering control module configured to control a drill steering system to direct the drill towards the area of interest.

7. The drill steering system of claim 1, wherein the steering control module is further configured to determine an orientation of the drill in the active well relative to the lateral wellbore, and further wherein the steering control module includes a bit steering control module configured to control a drill steering system to direct the drill in a desired direction to establish a desired orientation of the drill relative to the lateral wellbore.

8. The drill steering system of claim 1, wherein the transducer signals are generated by one or more electric dipoles.

9. A computer-readable storage medium with instructions stored thereon that, when executed, direct a processor to perform acts comprising:
receiving a first set of signals detected in an active well undergoing a drilling operation, the first set of signals being transmitted by at least one transducer array associated with a lateral wellbore, wherein the lateral wellbore and the active well are separated by a formation; and
analyzing the detected first set of signals to determine an area of interest in the formation.

10. The computer-readable storage medium of claim 9, further including instructions to direct a processor to perform acts comprising:
activating the at least one transducer array to transmit the first set of signals into the formation.

11. The computer-readable storage medium of claim 9, further including instructions to direct a processor to perform acts comprising:
directing a drill steering system to direct a drill in the active well towards the area of interest.

12. The computer-readable storage medium of claim 9, further including instructions to direct a processor to perform acts comprising:
determining a location of the area of interest based on electromagnetic field strength represented by the first set of signals propagated through the formation.

13. The computer-readable storage medium of claim 9, further including instructions to direct a processor to perform acts comprising:
directing a drill steering system to direct a drill in the active well to avoid the area of interest.

14. The computer-readable storage medium of claim 9, further including instructions to direct a processor to perform acts comprising:
receiving a second set of signals detected in the lateral wellbore; the second set of signals being transmitted through the formation by at least one transducer array associated with the active well; and
analyzing the detected second set of signals along with the detected first set of signals to determine an area of interest in the formation.

15. The computer-readable storage medium of claim 14, further including instructions to direct a processor to perform acts comprising:
directing the at least one transducer array associated with the active well to transmit the second set of signals into the formation.

16. The computer-readable storage medium of claim 14, further including instructions to direct a processor to perform acts comprising:
directing a drill steering system to direct a drill in the active well toward the area of interest.

17. A method of steering a drill bit comprising:
receiving information regarding waveforms propagated by one or more electric dipoles through a formation between a lateral wellbore and an active well being drilled; and
utilizing the information to determine an orientation of a drill in the active well relative to the lateral wellbore.

18. The method of claim 17, wherein utilizing further comprises one or more of:
utilizing the information to determine a distance between the drill in the active well and the lateral wellbore;
utilizing the information to determine an angle θ between the active well and the lateral wellbore; and
utilizing the information to determine one or more properties of the formation.

19. The method of claim 17, further comprising:
providing instructions to a steering system to alter a direction of the drill to establish a desired orientation of the drill relative to the lateral wellbore.

20. The method of claim 17, wherein the receiving further comprises:
receiving information regarding waveforms propagated by a first electric dipole of the one or more electric dipoles when the first electric dipole is at a first position; and
receiving information regarding waveforms propagated by the first electric dipole when the first electric dipole is at a second position;
